(19) United States
(12) Patent Application Publication
(10) Pub. No.: US 2019/0062968 A1
(43) Pub. Date: Feb. 28, 2019

(54) AUTOMOTIVE INTERIOR MATERIAL AND METHOD FOR MANUFACTURING THE SAME

(71) Applicant: SEOYON E-HWA CO., LTD., Seoul (KR)

(72) Inventors: Dong Won KIM, Chungcheongnam-do (KR); Ki Sung KIM, Chungcheongnam-do (KR); Byeong Sub KIM, Gyeonggi-do (KR)

(21) Appl. No.: 16/016,772

(22) Filed: Jun. 25, 2018

(30) Foreign Application Priority Data
Aug. 24, 2017 (KR) 10-2017-0107344

(51) Int. Cl. D04H 1/12; D04H 1/16; D04H 1/46; B32B 5/02; B32B 5/26; B32B 5/08; B32B 37/06; B32B 5/06; B32B 37/10

(52) U.S. Cl. CPC D04H 1/12; B32B 2305/28; D04H 1/46; B32B 5/022; B32B 5/26; B32B 5/08; B32B 37/06; B32B 5/06; B32B 37/10; D10B 2201/06; D10B 2321/022; D10B 2331/04; D10B 2505/12; B32B 2605/003; B32B 2255/02; B32B 2255/26; B32B 2262/065; B32B 2262/0276; B32B 2262/0253; B32B 2250/02; B32B 2250/20; B32B 2323/10; B32B 2367/00; B32B 2317/10; D04H 1/16

(57) ABSTRACT

Provided herein are an automotive interior material and a method for manufacturing the same. The automotive interior material is capable of allowing high rigidity and weight reduction to be implemented and allowing a bracket, a skin material, and other accessories to be easily attached to a surface of the automotive interior material, using a thermosetting resin and a multi-layered felt layer configured with a first felt layer made of a first material containing a natural fiber and a synthetic fiber, and a second felt layer attached on top of the first felt layer and made of a second material which contains a natural fiber and a synthetic fiber and is different from the first material in at least one of a component and a composition.

### CROSS-REFERENCE TO RELATED APPLICATIONS

This application claims priority to Korean Patent Application No. 10-2017-0107344, filed on Aug. 24, 2017, the disclosure of which is incorporated herein by reference in its entirety.

### BACKGROUND OF THE DISCLOSURE

### Field of the Disclosure

Exemplary embodiments of the present disclosure relate to an automotive interior material with which high rigidity and weight reduction are implemented using a thermosetting resin and a plurality of felt layers including a natural fiber and a synthetic fiber, by which an existing manufacturing process is maintained, and of which functionality is improved, and a method of manufacturing the same.

### Description of the Related Art

As disclosed in Korean Patent Laid-Open Publication No. 10-2003-0093823, natural fiber composite materials include a natural fiber reinforced board manufactured by needle punching a natural fiber and a chemical fiber, a composite material laminated with a natural fiber sheet and a polyolefin foam, a natural fiber/thermosetting binder in which a natural fiber is dipped into a thermosetting resin, and the like, and these natural fiber composite materials are used in manufacturing of a rear shelf, a trunk trim, a headliner, a door trim, and the like of a vehicle.

Among these natural fiber composite materials, the natural fiber/thermosetting binder, which is a high rigidity material and is developed to replace the existing natural composite material and plastic injection material in order to implement weight reduction, is manufactured by injecting a thermosetting resin on upper and lower surfaces of a felt layer, dipping the felt layer, and performing hot pressing and forming on the dipped felt layer, and thus a high level of weight reduction may be achieved due to the usage of the thermosetting resin implementing high rigidity, but there is a problem in that a core is manufactured and then a bracket, a skin material, and other accessories should be attached to a surface of the core using a hot melt or an adhesive. Further, since the thermosetting binder is used, there may occur surface quality deterioration on the surface of the core due to air appearance phenomenon of a binder resin.

### SUMMARY OF THE DISCLOSURE

An object of the present disclosure is to provide an automotive interior material with which high rigidity and weight reduction can be implemented and for which a bracket, a skin material, and other accessories can be easily attached to a surface of the automotive interior material by stacking, in a single process without a separate additional process, a first felt layer made of a first material containing a natural fiber and a synthetic fiber, and a second felt layer attached on top of the first felt layer and made of a second material which contains a natural fiber and a synthetic fiber and is different from the first material in at least one of a component and a composition, and a method for manufacturing the same.

Other objects and advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

Provided herein is an automotive interior material including a first felt layer made of a first material containing a natural fiber and a synthetic fiber, a second felt layer attached on top of the first felt layer and made of a second material which contains a natural fiber and a synthetic fiber and is different from the first material in at least one of a component and a composition, and a coating layer made of a third material containing a thermosetting resin and attached to at least one of an upper surface and a lower surface of a multi-layered felt layer configured with the first felt layer and the second felt layer, wherein the first material has a weight ratio of the natural fiber to the synthetic fiber in a range of 9:1 to 8:2, and the second material has a weight ratio of the natural fiber to the synthetic fiber in a range of 7:3 to 3:7.

The first material and the second material may include different types of synthetic fibers.

More specifically, the natural fiber of the first material or the second material may be made of one or more fiber materials selected from the group consisting of a jute, kenaf, sisal, flax, and a bamboo.

Further, the synthetic fiber of the first material or the second material may be made of one or more fiber materials selected from the group consisting of polypropylene, polyester, and nylon.

The thermosetting resin may be made of one or more resin materials selected from the group consisting of a urethane resin, an epoxy resin, an acrylic resin, a phenol resin, an amino resin, and a mixture thereof.

The coating layer may be included at a ratio of 10 to 100% by weight relative to a total weight of the multi-layered felt layer configured with the first felt layer and the second felt layer.

The automotive interior material may further include a third felt layer attached to an upper surface or a lower surface of the coating layer and made of a fourth material containing a natural fiber and a synthetic fiber.

The coating layer may be attached to at least one of a lower surface of the first felt layer and an upper surface of the second felt layer by being heated, compressed, and formed at a temperature in a rage of 100° C. to 250° C. for 10 seconds to 60 seconds.

Provided herein is a method for manufacturing an automotive interior material, the method including a first operation of forming a multi-layered felt layer configured with a first felt layer made of a first material which is prepared by a natural fiber and a synthetic fiber, wherein a weight ratio of the natural fiber to the synthetic fiber is in a range of 9:1 to 8:2, and a second felt layer attached on top of the first felt layer 110 and made of a second material which is prepared by a natural fiber and a synthetic fiber, wherein a weight ratio of the natural fiber to the synthetic fiber is in a range of 7:3 to 3:7, a second operation of forming a coating layer made of a third material containing a thermosetting resin on an upper surface or a lower surface of the multi-layered felt layer configured with the first felt layer and the second felt layer which are formed in the first operation, and a third operation of heating and compressing a stacked structure at which the coating layer formed in the second operation is stacked at a temperature in a range of 100° C. to 250° C. for 10 seconds to 60 seconds to form the automotive interior material.

The first felt layer and the second felt layer may be manufactured through carding and needle punching, and the multi-layered felt layer configured with the first felt layer and the second felt layer may be manufactured in the same manufacturing process of the first felt layer and the second felt layer without a separate additional process.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating an automotive interior material according to one embodiment of the present disclosure;

FIG. 2 is a diagram illustrating an automotive interior material according to one embodiment of the present disclosure; and

FIG. 3 is a diagram illustrating a method for manufacturing an automotive interior material according to one embodiment of the present disclosure.

### DESCRIPTION OF SPECIFIC EMBODIMENTS

In order to facilitate understanding of the features of the present disclosure, an automotive interior material and a method for manufacturing the same, which are related to embodiments of the present disclosure, will be described in detail below.

In order to facilitate understanding of the embodiments which will described below, it should be noted that, in giving reference numerals to components of the drawings, the same reference numerals are given to the same components even though the same components are shown in different drawings. Also, in the following description of the present disclosure, if a detailed description of related known configurations or functions is determined to obscure the gist of the present disclosure, the detailed description thereof will be omitted.

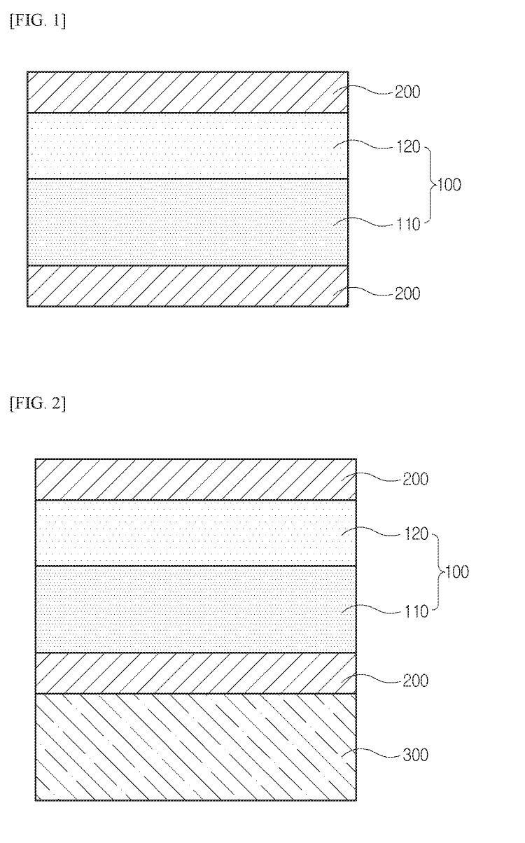

An automotive interior material and a method for manufacturing the same of the present disclosure will be described in more detail with reference to FIGS. 1 to 3.

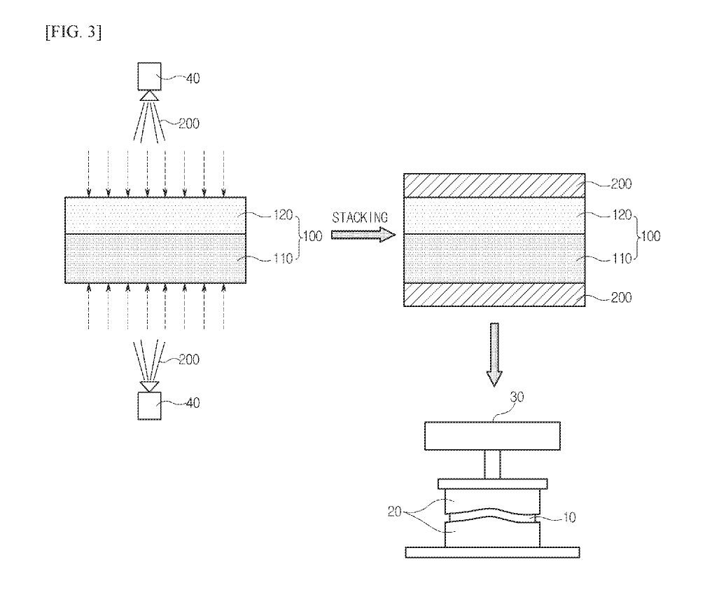

FIGS. 1 and 2 are diagrams illustrating an automotive interior material according to one embodiment of the present disclosure, and the automotive interior material includes a coating layer 200 and a multi-layered felt layer 100. In the present disclosure, there is a difference in stacked structure according to the presence or absence of a third felt layer 300, but the automotive interior material commonly includes a structure in which a first felt layer 110, a second felt layer 120 attached on top of the first felt layer 110, and the coating layer 200 made of a third material containing a thermosetting resin and attached to at least one of upper and lower surfaces of the multi-layered felt layer 100 configured with the first felt layer 110 and the second felt layer 120 are stacked.

As shown in FIG. 1, the stacked structure of the present disclosure may be formed in the order of the coating layer 200, the first felt layer 110, the second felt layer 120, and the coating layer 200, and alternatively, as shown in FIG. 2, the stacked structure may be formed in the order of the coating layer 200, the first felt layer 110, the second felt layer 120, the coating layer 200, and the third felt layer 300. However, this is merely an example and the stacked structure is not limited to the above-described stacking orders.

The automotive interior material of the present disclosure includes the first felt layer 110 made of a first material containing a natural fiber and a synthetic fiber, the second felt layer 120 attached on top of the first felt layer 110 and made of a second material which contains a natural fiber and a synthetic fiber and is different from the first material in component or composition, and the coating layer 200 made of the third material containing a thermosetting resin and attached to at least one of the upper and lower surfaces of the multi-layered felt layer 100 configured with the first felt layer 110 and the second felt layer 120, such that rigidity may be improved and a bracket and a skin material may be easily attached to a front surface and a rear surface of the automotive interior material.

The first felt layer 110 of the present disclosure is made of a first material containing a natural fiber and a synthetic fiber, and the second felt layer 120 is made of a second material which contains a natural fiber and a synthetic fiber and is different from the first material in at least one of a component and a composition.

More specifically, the first material may have a weight ratio of the natural fiber to the synthetic fiber in the range of 9:1 to 6:4, and the second material may have a weight ratio of the natural fiber to the synthetic fiber in the range of 7:3 to 3:7.

The synthetic fiber of the first material has a high melting point to exhibit an effect of improving strength, and the synthetic fiber of the second material has excellent compatibility with the bracket and the skin material to facilitate adhesion with the bracket and the like.

In order to improve strength of a composite material, the first material may include a weight ratio of the natural fiber to the synthetic fiber in the range of 9:1 to 6:4. When the synthetic fiber is contained less than 10%, there is a problem in that a bonding force between fibers in a carding process of felt is in sufficient and a loss rate rises to cause degradation of physical properties, and when the synthetic fiber is contained exceeding 40%, there is a problem in that a content of the natural fiber serving as a filler decreases to cause degradation of physical properties and an rise of production cost. Further, when the natural fiber is contained in less than 60%, the same problem as in the case in which the synthetic fiber is contained exceeding 40% may occur, and when the natural fiber is contained exceeding 90%, the same problem as in the case in which the synthetic fiber is contained less than 10% may occur.

Further, the second material may have a weight ratio of the natural fiber to the synthetic fiber in the range of 7:3 to 3:7 so as to facilitate adhesion of the bracket and the skin material. When the synthetic fiber is contained less than 30%, there occurs a problem in that vibrational adhesion of a bracket is insufficient to cause detachment of parts when the parts are installed, and when the synthetic fiber is contained exceeding 70%, there occurs a problem in that a bending phenomenon occurs and production cost rises due to a contraction ratio between first felt layer and second felt layer. Further, when the natural fiber is contained less than 30%, the same problem as in the case in which the synthetic fiber is contained exceeding 70% may occur, and when the natural fiber is contained exceeding 70%, the same problem as in the case in which the synthetic fiber is contained less than 30% may occur.

According to a more preferred embodiment of the present disclosure, the first material and the second material may include different kinds of synthetic fibers, and the weight ratio of the natural fiber to the synthetic fiber in the first material may be different from the weight ratio of the natural fiber to the synthetic fiber in the second material.

More specifically, each of the first felt layer 110 and the second felt layer 120 includes a natural fiber and a synthetic fiber, the natural fiber is made of one or more fiber materials selected from the group consisting of a jute, kenaf, sisal, flax, and a bamboo, and the synthetic fiber is made of one or more fiber materials selected from the group consisting of polypropylene, polyester, low melting point polyester, and nylon, but the present disclosure is not limited to the above-described examples.

Each of the first felt layer 110 and the second felt layer 120 of the present disclosure is manufactured by carding and needle punching, and the first felt layer 110 and the second felt layer 120 are manufactured into a single multi-layered felt layer 100 in the same process by varying a composition of materials input to a carding device without a separate additional process.

As one example of the present disclosure, a weight ratio of the first felt layer 110 to the second felt layer 120 of the present disclosure may be in the range of 7:3 to 5:5.

More specifically, the first felt layer 110 serves to reinforce strength in the multi-layered felt layer 100, and the second felt layer 120 serves to improve adhesion power of brackets. Therefore, when the second felt layer 120 is contained exceeding 50%, there may occur a problem in that strength is insufficient and production cost rises, and when the second felt layer 120 is contained less than 30%, there may occur a problem in that adhesion power of brackets is insufficient.

The present disclosure includes the coating layer 200 attached to at least one of the upper and lower surfaces of the multi-layered felt layer 100 configured with the first felt layer 110 and the second felt layer 120 and made of a third material containing a thermosetting resin, and the thermosetting resin of the coating layer 200 may be made of one or more resin materials selected from the group consisting of a urethane resin, an epoxy resin, an acrylic resin, a phenol resin, an amino resin, and a mixture thereof and may further include an additive.

The additive is one or more selected from the group consisting of a glass fiber, a mineral fiber, talc, calcium carbonate, and a carbon fiber, but the present disclosure is not limited to the above-described examples.

Further, the coating layer 200 of the present disclosure may be formed by injecting a thermosetting resin through a resin injection nozzle 40 and may be contained in the range of 10 to 100% by weight relative to a total weight of the multi-layered felt layer 100 configured with the first felt layer 110 and the second felt layer 120, but the present disclosure is not limited thereto.

When the coating layer 200 is less than 10% by weight of the total weight of the multi-layered felt layer 100 configured with the first felt layer 110 and the second felt layer 120, an effect of strength improvement is not significant even after the thermosetting resin is cured, and when the coating layer 200 exceeds 100% by weight, an increment in weight of a base material is excessive and thus weight reduction which is the objective of the present disclosure may not be achieved.

As another example of the present disclosure, the automotive interior material includes a third felt layer 300 attached to an upper surface or a lower surface of the coating layer 200 and made of a fourth material containing a natural fiber and a synthetic fiber.

More specifically, a natural fiber and a synthetic fiber having a weight ratio in the range of 9:1 to 6:4 may be contained in the third felt layer 300, and the third felt layer 300 may serve to reinforce strength and improve compatibility with a skin material. Further, when the third felt layer 300 contains the synthetic fiber less than 10%, there is a problem in that a bonding force between fibers in a carding process of felt is in sufficient and a loss rate rises to cause degradation of physical properties, and when the third felt layer 300 contains the synthetic fiber exceeding 40%, there is a problem in that a content of the natural fiber serving as a filler decreases to cause degradation of physical properties and a rise of production cost. Furthermore, when the natural fiber is contained in less than 60%, the same problem as in the case in which the synthetic fiber is contained exceeding 40% may occur, and when the natural fiber is contained exceeding 90%, the same problem as in the case in which the synthetic fiber is contained less than 10% may occur.

FIG. 3 is a diagram illustrating a method for manufacturing an automotive interior material according to one embodiment of the present disclosure.

Referring to FIG. 3, the method of manufacturing an automotive interior material of the present disclosure includes a first operation of forming a multi-layered felt layer 100 configured with a first felt layer 110 made of a first material containing a natural fiber and a synthetic fiber, and a second felt layer 120 attached on top of the first felt layer 110 and made of a second material different from the first material in at least one of a component or a composition, a second operation of forming a coating layer 200 made of a third material containing a thermosetting resin on an upper surface or a lower surface of the multi-layered felt layer 100 configured with the first felt layer 110 and the second felt layer 120 which are formed in the first operation, and a third operation of heating and compressing a stacked structure at which the coating layer 200 formed in the second operation is stacked at a temperature in the range of 100° C. to 250° C. for 10 seconds to 60 seconds to form the automotive interior material.

More specifically, the automotive interior material may include a stacked structure in which, after the coating layer 200 is formed in the second operation, a third felt layer 300 attached to the upper surface or the lower surface of the formed coating layer 200 and made of a fourth material containing a natural fiber and a synthetic fiber is additionally stacked.

The stacked structure formed in the second operation may be formed in the order of the coating layer 200, the first felt layer 110, the second felt layer 120, and the coating layer 200, and alternatively, the stacked structure may be formed in the order of the coating layer 200, the first felt layer 110, the second felt layer 120, the coating layer 200, and the third felt layer 300, but the present disclosure is not limited to the above-described orders.

The third operation of heating, compressing, and forming includes curing the thermosetting resin of the coating layer 200 to shape the thermosetting resin. It is possible to prevent a delamination phenomenon of a deep-draw portion, which occurs when cold forming is carried out on a conventional press flat plate after heating and pressing, and to prevent a burst of an edge portion caused by curing of the thermosetting resin. As in one embodiment of the present disclosure, when heating and compressing are carried out using a heating and forming mold 20, even though the thermosetting resin of the coating layer 200 is pre-cured by heat, the thermosetting resin is not delaminated or broken at a flection portion and the deep-draw portion.

Further, in the heating, compressing, and forming, a base material 10 is preferably formed through heating and compressing at a temperature in the range of 100° C. to 250° C., for 10 seconds to 60 seconds in consideration of melting points of the natural fiber and the synthetic fiber. Such a forming condition may be appropriately adjusted according to the property of a material constituting the base material 10.

The automotive interior material according to one embodiment of the present disclosure may be manufactured as a final product through attachment of brackets, skin materials, and the like. The brackets are injection products using a polyolefin-based resin, and since brackets are excellent in compatibility with the second felt layer 120, the brackets may be easily attached by applying conventional fusing and conventional rear injection, and the skin materials may be attached using a non-woven fabric made of a polyolefin-based material or a polyester-based material. Such a non-woven fabric layer forms a surface of the product and may implement various textures, colors, and mechanical and chemical properties according to the kind of non-woven fabric.

Hereinafter, the present disclosure will be described in more detail with reference to Examples. The Examples are provided only to describe the present disclosure in more substantially, and it will be obvious to those skilled in the art that the scope of the present disclosure is not limited to these Examples according to the gist of the present disclosure.

### EXAMPLES

[Derivation of Optimal Composition Ratio of First Felt Layer to Second Felt Layer]

A first felt layer was made of a combination of a natural fiber (kenaf) and a synthetic fiber (polyester), a second felt layer was made of a combination of a natural fiber (kenaf) and a synthetic fiber (polypropylene), and the first felt layer and the second felt layer were manufactured to have different composition ratios of the natural fiber to the synthetic fiber.

Further, the first felt layer and the second felt layer having various composition ratios were manufactured into a single multi-layered felt layer in the same process and then flexural strength and adhesive power were measured, and thus an optimal composition ratio having excellence in both flexural strength and adhesive power was derived.

Here, the multi-layered felt layer was manufactured to have a weight of 1,000 g/m², the first felt layer was manufactured to have a weight of 600 g/m², and the second felt layer was manufactured to have a weight of 400 g/m².

TABLE 1

| | First Felt Layer | Second Felt Layer |
|---|---|---|
| | Natural Fiber vs. | Natural Fiber vs. |
| | Synthetic Fiber | Synthetic Fiber |
| Sample 1-1 | 50:50 | 90:10 |
| Sample 1-2 | 60:40 | 90:10 |
| Sample 1-3 | 60:40 | 70:30 |
| Sample 1-4 | 60:40 | 50:50 |
| Sample 1-5 | 60:40 | 30:70 |
| Sample 1-6 | 70:30 | 90:10 |
| Sample 1-7 | 70:30 | 50:50 |
| Sample 1-8 | 90:10 | 70:30 |
| Sample 1-9 | 90:10 | 50:50 |
| Sample 1-10 | 90:10 | 30:70 |

The first felt layer and the second felt layer were manufactured as described in Table 1, and the multi-layered felt layer having a size of 300 mm in width, 300 mm in length, and 2 mm in thickness was manufactured through heating and compressing at a temperature of 150° C. Further, in order to measure strength, a test sample having a size of 150 mm width and 50 mm length was manufactured and flexural strength was measured at a test speed of 5 mm/min using a universal testing machine. Further, adhesive power of a bracket was measured.

TABLE 2

| | | Adhesive | Flexural | Adhesive | | |
|---|---|---|---|---|---|---|
| | Flexural Strength | Power | Strength | Power | Average | |
| | (MPa) | (kgf) | Percentage | Percentage | Percentage | Ranking |
| Sample 1-1 | 22.2 | 20 | 80.43 | 52.63 | 66.53 | 10 |
| Sample 1-2 | 24.2 | 21 | 87.68 | 55.26 | 71.47 | 9 |
| Sample 1-3 | 23.5 | 29 | 85.14 | 76.32 | 80.73 | 7 |
| Sample 1-4 | 22.7 | 32 | 82.25 | 84.21 | 83.23 | 6 |
| Sample 1-5 | 22.0 | 36 | 79.71 | 94.74 | 87.22 | 4 |
| Sample 1-6 | 27.6 | 19 | 100.00 | 50.00 | 75.00 | 8 |
| Sample 1-7 | 26.5 | 29 | 96.01 | 76.32 | 86.17 | 5 |
| Sample 1-8 | 27.5 | 29 | 99.64 | 76.32 | 87.98 | 3 |
| Sample 1-9 | 26.2 | 33 | 94.93 | 86.84 | 90.88 | 2 |
| Sample 1-10 | 25.0 | 38 | 90.58 | 100.00 | 95.29 | 1 |

Table 2 shows test result values of the multi-layered felt layers of Samples 1-1 to 1-10 and data and results calculated to obtain a sample having excellence in both flexural strength and adhesive power from the test result values.

In Table 2, the percentage of the flexural strength was obtained by setting highest flexural strength (27.6 MPa of Sample 1-6) among the flexural strength values of Samples 1-1 to 1-10 as 100% and calculating a percentage of flexural strength on the basis of the highest flexural strength, and the percentage of the adhesive power was obtained by setting highest adhesive power (38 kgf of Sample 1-10) among the adhesive power values of Samples 1-1 to 1-10 as 100% and calculating a percentage of adhesive power on the basis of the highest adhesive power. Further, the average percentage is an average of the percentage of the flexural strength and the percentage of the adhesive power, and the ranking is ranked from a highest value of the average percentage.

As shown in Table 2, it can be seen that the multi-layered felt layers of Samples 8 to 10 were excellent in average values of the flexural strength and the adhesive power. That is, when the first felt layer is made of a natural fiber and a synthetic fiber having a weight ratio of 9:1, and the second felt layer is made of a natural fiber and a synthetic fiber having a weight ratio in the range of 7:3 to 3:7, it is possible to manufacture an optimal multi-layered felt layer satisfying the flexural strength and the adhesive power.

Accordingly, in the present disclosure, a first material having a weight ratio of the natural fiber to the synthetic fiber in the range of 9:1 to 8:2 was used as the first felt layer, and a second material having a weight ratio of the natural fiber to the synthetic fiber in the range of 7:3 to 3:7 was used as the second felt layer.

Derivation of Optimal Weight Ratio of Coating Layer

In order to derive an optimal weight ratio of a coating layer, the first felt layer was made of a first material in which a weight ratio of a natural fiber (kenaf) to a synthetic fiber (polyester) is 9:1, and the second felt layer was made of a second material in which a weight ratio of a natural fiber (kenaf) to a synthetic fiber (polyester) is 5:5.

Further, the coating layer was made of a third material containing urethane which is a thermosetting resin and was formed by injecting the third material onto the multi-layered felt layer at various weights. The stacked structure in which the urethane was formed as the coating layer was formed and cured into an automotive interior material through heating and compressing at 150° C., for 60 seconds using a hot pressing mold.

TABLE 3

| | | | Stacked |
|---|---|---|---|
| | Composition | | Structure |
| Sample | Multilayered Felt Layer 1,000 g/m² | coating layer | FIG. 1 |
| 2-1 | (first felt layer 600 g/m² + | 10 g/m² | |
| | second felt layer 400 g/m²) | | |
| Sample | Multilayered Felt Layer 1,000 g/m² | coating layer | FIG. 1 |
| 2-2 | (first felt layer 600 g/m² + | 100 g/m² | |
| | second felt layer 400 g/m²) | | |
| Sample | Multilayered Felt Layer 1,000 g/m² | coating layer | FIG. 1 |
| 2-3 | (first felt layer 600 g/m² + | 200 g/m² | |
| | second felt layer 400 g/m²) | | |
| Sample | Multilayered Felt Layer 1,000 g/m² | coating layer | FIG. 1 |
| 2-4 | (first felt layer 600 g/m² + | 400 g/m² | |
| | second felt layer 400 g/m²) | | |
| Sample | Multilayered Felt Layer 1,000 g/m² | coating layer | FIG. 1 |
| 2-5 | (first felt layer 600 g/m² + | 1,000 g/m² | |
| | second felt layer 400 g/m²) | | |
| Sample | Multilayered Felt Layer 1,000 g/m² | coating layer | FIG. 1 |
| 2-6 | (first felt layer 600 g/m² + | 1,200 g/m² | |
| | second felt layer 400 g/m²) | | |

As shown in Table 3, the coating layer was formed on the multi-layered felt layer at various weights to manufacture the automotive interior material, and then flexural strength and adhesive power of a bracket were measured.

TABLE 4

| | | Flexural | Adhesive |
|---|---|---|---|
| | Weight | Strength | Power |
| | (g/m²) | (MPa) | (kgf) |
| Sample 2-1 | 1,010 | 25.6 | 25.0 |
| Sample 2-2 | 1,100 | 33.2 | 27.0 |
| Sample 2-3 | 1,200 | 37.8 | 30.0 |
| Sample 2-4 | 1,400 | 47.6 | 32.0 |
| Sample 2-5 | 2,000 | 65.2 | 32.0 |
| Sample 2-6 | 2,200 | 65.8 | 27.0 |

As shown in Table 4, it can be seen that Samples 2-2 to 2-5 exhibited both flexural strength and adhesive power which are higher than a predetermined level, Sample 2-1 exhibited both flexural strength and adhesive power which are lower than those of Samples 2-2 to 2-5, and Sample 2-6 exhibited high flexural strength but exhibited adhesive power relative to a weight lower than those of Samples 2-1 to 2-5.

Therefore, when the coating layer is provided at a ratio of 10 to 100% by weight relative to a total weight of the multi-layered felt layer, both flexural strength and adhesive power of the coating layer are excellent, so that the coating layer was formed within the above-described weight ratio range in the present disclosure.

[Manufacture of Automotive Interior Material]

An automotive interior material satisfying the composition ratio and the weight ratio, which were selected as described above, was manufactured and compared with a conventional automotive interior material in flexural strength and adhesive power of a bracket.

In the automotive interior material, the first felt layer of the multi-layered felt layer was made of a first material in which a weight ratio of a natural fiber (kenaf) to a synthetic fiber (polyester) was 9:1, and the second felt layer was made of a second material in which a weight ratio of a natural fiber (kenaf) to a synthetic fiber (polypropylene) was 5:5. Further, the third felt layer was made of a fourth material in which a weight ratio of a natural fiber (kenaf) to a synthetic fiber (polyester) was 7:3.

Furthermore, the coating layer was made of a third material containing urethane which is a thermosetting resin, and the automotive interior material was manufactured by injecting the third material at a ratio of 5 to 100% by weight relative to a total weight of the multi-layered felt layer configured with the first felt layer and the second felt layer. The stacked structure in which the urethane was formed as the coating layer was formed and cured into the automotive interior material through heating and compressing at 150° C. for 60 seconds using a hot pressing mold.

A more detailed composition of the automotive interior material is shown in the following Table 5.

TABLE 5

| | | | Stacked |
|---|---|---|---|
| | Composition | | Structure |
| Example 1 | Multilayered Felt Layer 1,000 g/m² | coating | FIG. 1 |
| | (first felt layer 600 g/m² + | layer | |
| | second felt layer 400 g/m²) | 100 g/m² | |
| Example 2 | Multilayered Felt Layer 1,000 g/m² | coating | FIG. 1 |
| | (first felt layer 600 g/m² + | layer | |
| | second felt layer 400 g/m²) | 200 g/m² | |
| Example 3 | Multilayered Felt Layer 1,000 g/m² | coating | FIG. 1 |
| | (first felt layer 600 g/m² + | layer | |
| | second felt layer 400 g/m²) | 400 g/m² | |
| Example 4 | Multilayered Felt Layer 1,000 g/m² | coating | FIG. 1 |
| | (first felt layer 600 g/m² + | layer | |
| | second felt layer 400 g/m²) | 1,000 g/m² | |
| Example 5 | Multilayered Felt Layer 600 g/m² | coating | FIG. 1 |
| | (first felt layer 300 g/m² + | layer | |
| | second felt layer 300 g/m²) | 600 g/m² | |
| Example 6 | Multilayered Felt Layer 1,200 g/m² | coating | FIG. 2 |
| | (first felt layer 400 g/m² + | layer | |
| | second felt layer 400 g/m²) + | 600 g/m² | |
| | third felt layer 400 g/m²) | | |

| | |
|---|---|
| Compar- | Felt layer 800 g/m² + |
| ative | Polypropylene (PP) fiber 800 g/m² + |
| Example 1 | Polypropylene (PP) film paper 200 g/m² |

The stacked structures of Examples 1 to 5 are structures stacked in the order of the coating layer, the first felt layer, the second felt layer, and the coating layer in FIG. 1, and the stacked structure of Example 6 is a structure stacked in the order of the coating layer, the first felt layer, the second felt layer, the coating layer, and the third felt layer.

Further, Comparative Example 1 is a conventional automotive interior material.

The test sample manufactured as described above was tested and flexural strength and adhesive power of a bracket were measured and shown in the following Table 6.

TABLE 6

| | | Flexural | Adhesive |
|---|---|---|---|
| | Weight | Strength | Power |
| | (g/m²) | (MPa) | (kgf) |
| Example 1 | 1,100 | 33.2 | 27.0 |
| Example 2 | 1,200 | 37.8 | 30.0 |
| Example 3 | 1,400 | 47.6 | 32.0 |
| Example 4 | 2,000 | 65.2 | 32.0 |
| Example 5 | 1,200 | 35.6 | 33.0 |
| Example 6 | 1,800 | 54.2 | 40.0 |
| Comparative Example 1 | 1,800 | 36.7 | 32.0 |

Table 6 shows the test results of the automotive interior materials of Examples 1 to 6 and Comparative Example 1. As shown in Table 6, it can be seen that the flexural strength and the adhesive power of Example 6, which was manufactured to have a weight the same as that of Comparative Example 1 which is the conventional automotive interior material, are respectively increased about 50% and about 25% as compared with those of Comparative Example 1.

Further, since the weight of each of Example 2 and Example 5, which exhibited the flexural strengths and the adhesive powers similar to those of Comparative Example 1, has a weight of 700 g/m² that is lighter than the weight of Comparative Example 1, weight reduction of about 40% may be achieved.

Therefore, since the automotive interior material according to the embodiments of the present disclosure has flexural strength and adhesive power which are higher than those of the conventional automotive interior material on the basis of the same weight, production cost can be reduced and weight reduction can be achieved.

In accordance with the present disclosure, there are provided an automotive interior material with which high rigidity and weight reduction can be implemented using a thermosetting resin and a multi-layered of felt layer including a natural fiber and a synthetic fiber and on which brackets, skin materials, and other accessories can be attached to a surface of the automotive interior material using an existing manufacturing process without a material, such as a hot melt, an adhesive, or a reinforcing film, and an additional process, and a method of manufacturing the same.

Although the specific embodiments of the present disclosure have been illustrated and described, it should be understood that various alternations and modifications of the present disclosure can be devised by those skilled in the art to which the present disclosure pertains without departing from the spirit and scope of the present disclosure, which are defined by the appended claims.

What is claimed is:

1. An automotive interior material, comprising:
a first felt layer made of a first material containing a natural fiber and a synthetic fiber;
a second felt layer attached on top of the first felt layer and made of a second material which contains a natural fiber and a synthetic fiber and is different from the first material in at least one of a component and a composition; and
a coating layer made of a third material containing a thermosetting resin and attached to at least one of an upper surface and a lower surface of a multi-layered felt layer configured with the first felt layer and the second felt layer,
wherein the first material has a weight ratio of the natural fiber to the synthetic fiber in a range of 9:1 to 8:2, and the second material has a weight ratio of the natural fiber to the synthetic fiber in a range of 7:3 to 3:7.

2. The automotive interior material of claim 1, wherein the first material and the second material include different types of synthetic fibers.

3. The automotive interior material of claim 1, wherein the natural fiber of the first material or the second material is made of one or more fiber materials selected from the group consisting of a jute, kenaf, sisal, flax, and a bamboo.

4. The automotive interior material of claim 1, wherein the synthetic fiber of the first material or the second material is made of one or more fiber materials selected from the group consisting of polypropylene, polyester, and nylon.

5. The automotive interior material of claim 1, wherein the thermosetting resin is made of one or more resin materials selected from the group consisting of a urethane resin, an epoxy resin, an acrylic resin, a phenol resin, an amino resin, and a mixture thereof.

6. The automotive interior material of claim 1, wherein the coating layer is included at a ratio of 10 to 100% by weight relative to a total weight of the multi-layered felt layer configured with the first felt layer and the second felt layer.

7. The automotive interior material of claim 1, further comprising:
a third felt layer attached to an upper surface or a lower surface of the coating layer and made of a fourth material containing a natural fiber and a synthetic fiber.

8. The automotive interior material of claim 1, wherein the coating layer is attached to at least one of a lower surface of the first felt layer and an upper surface of the second felt layer by being heated, compressed, and formed at a temperature in a rage of 100° C. to 250° C. for 10 seconds to 60 seconds.

9. A method for manufacturing an automotive interior material, the method comprising:
a first operation of forming a multi-layered felt layer configured with a first felt layer made of a first material which is prepared by a natural fiber and a synthetic fiber, wherein a weight ratio of the natural fiber to the synthetic fiber is in a range of 9:1 to 8:2, and a second felt layer attached on top of the first felt layer and made of a second material which is prepared by a natural fiber and a synthetic fiber, wherein a weight ratio of the natural fiber to the synthetic fiber is in a range of 7:3 to 3:7;
a second operation of forming a coating layer made of a third material containing a thermosetting resin on an upper surface or a lower surface of the multi-layered felt layer configured with the first felt layer and the second felt layer which are formed in the first operation; and
a third operation of heating and compressing a stacked structure at which the coating layer formed in the second operation is stacked at a temperature in a range of 100° C. to 250° C. for 10 seconds to 60 seconds to form the automotive interior material.

10. The method of claim 9, wherein the first felt layer and the second felt layer are manufactured through carding and needle punching, and the multi-layered felt layer configured with the first felt layer and the second felt layer is manufactured in the same manufacturing process of the first felt layer and the second felt layer without a separate additional process.
